(19) United States
(12) Patent Application Publication
(10) Pub. No.: US 2025/0112787 A1
(43) Pub. Date: Apr. 3, 2025

(54) Public Key Infrastructure (PKI) Monitoring Systems and Methods

(71) Applicant: PKI Solutions LLC, Portland, OR (US)

(72) Inventor: Mark B. Cooper, Portland, OR (US)

(21) Appl. No.: 18/480,057

(22) Filed: Oct. 3, 2023

(51) Int. Cl. H04L 9/32; H04L 9/08

(52) U.S. Cl. CPC H04L 9/3263; H04L 9/0877

(57) ABSTRACT

A public key infrastructure (PKI) monitoring system that include a controller communicatively coupled to one or more agents that are installed on one or more components of a PKI system. The agents collect data regarding the functionality and operation of the component and receive instructions from the controller. The controller receives data from the agents and monitors the PKI system for potential security issues. Additionally, the controller can initiate a functionality check of one of the PKI system components to determine if the component is properly function and usable within the PKI system.

### BACKGROUND

Public key infrastructure (PKI) systems underpin the security of much of today's electronic systems. Using PKI systems, users can be authenticated for use of various systems and, similarly, users can confidently and securely interact with such systems in secure environments. With such PKI systems, each party obtains a level of trust in each other that allows for the exchange and use of information and resources in a secure manner.

Many companies employ internal PKI systems to assist with managing and securing access to various resources. However, the companies using internal PKI systems oftentimes lack tools and insight into their PKI systems. While network managers and cybersecurity personnel and teams can provide some of this monitoring, they are often not well versed in PKI systems and securing them. Due to this lack of monitoring and insights into the operational status of their PKI systems, companies and network managers often only realize there is a problem with their PKI systems when problems arise. This can lead to significant downtimes until these issue are resolved.

Many network threat detection and intrusion products do not monitor a customer's PKI systems. Instead these systems typically monitor a network and/or system(s) as a whole for suspicious activity and/or patterns. Often, this monitoring is not extended to the PKI system and its components and/or the monitoring is not attuned to the functionality of the PKI system. As such, these existing systems, methods and product do not provide adequate monitoring of a PKI system for a customer.

Additionally, PKI systems are potential points of vulnerability that malicious actors can attempt to exploit. While there are a number of products that help customers secure their networks and detect intrusions, many of these products are very lacking when it comes to security regarding PKI. This can be a detriment, as a customer's PKI is something that is often set-up and then forgotten about as long as it continues to function as expected. Because of this, vulnerabilities are often not caught until it is too late and there can be significant downtimes since the customers lack insight into the functionality of their PKI systems.

Accordingly, there is a need for systems, methods and/or tools to provide users with insight into their PKI systems. With such insights into the operational status of their PKI systems, user could detect and resolve such issues promptly, reducing or eliminating potential downtime.

### SUMMARY

In an embodiment, a public key infrastructure (PKI) monitoring system can include a controller and one or more components of a PKI system. Each of the one or more components of the PKI system can include an agent installed thereon. The agents can communicate with the controller and can collect data regarding the component and communicate such to the controller. Additionally, the agents can receive instructions from the controller. The controller includes a functionality module that is configured to query a first component of the PKI system and generate a functionality status of the first component based on the response to the query.

In another embodiment, the functionality module of the PKI monitoring system can query a second component that the first component interacts with. The query of the second component can be a part of the functionality check of the first component, with the functionality status of the first component being further based on the query of the second component.

In a further embodiment, the functionality status of a component of the PKI system can be determined to be functional or non-functional, as base d on the functionality module of the PKI monitoring system. In an example where the status of a component is non-functional, the functionality module can initiate a diagnostic tool to diagnose an issue related to the functionality of the component with the non-functional status. In yet a further example, the functionality module can provide a remedy or guidance to correct the issue related to the functionality of the component, such as a non-functional status of the component. The remedy can be based at least in part on the diagnosis of the issue.

In yet a further embodiment, the functionality module can perform third and fourth queries to determine a further functionality status of the first component. The third and fourth queries can be in addition to the first and second queries, as described above, that were used to determine an initial functionality status of the component of the PKI system. In an example, the third query can be directed to the first component and the further functionality status of the first component can be based at least in part on the response to this third query. In another example, the fourth query can be directed to the second component of the PKI system, that interacts with the first component, and the further functionality status can be based at least in part on the response to the fourth query by the second component of the PKI system.

In yet another embodiment, at least a portion of the PKI system components can be part of or within a private PKI system. In an example, a private PKI system can be one managed, owned, or administered by a private entity, such as an individual or company. In a further embodiment, at least a portion of the components of the PKI system can be within or part of a public PKI system. Additionally, or alternatively, the private PKI system can be one in which the components of such are reserved for use by a particular entity and not available to other entities. In an example, a public PKI system can be one managed, owned, or administered by an entity other than the user of the PKI system and/or that has multiple other users.

In an embodiment, a method of monitoring a PKI system can include initiating a functionality status check of a first component of the PKI system, performing a first check of the first component, performing a second check of the first component, initiating a dependency check of the first component and the functionality status of the first component can be based at least in part on the first and second checks and the dependency check of the first component.

In an example, the first check of the first component can include determining a first availability status of a first functionality of the first component. The functionality status of the first component can be based at least in part on this determination of the first availability status.

In another example, the second check of the first component can include determining a second availability status of a second functionality of the first component. The second functionality of the first component can be different than the first functionality of the first component that is referenced above. The functionality status of the first component can be based at least in part on this determination of the second availability status.

In yet another example, the dependency check of the first component can include determining an availability of a functionality of the first component that relies on a second component of the PKI system. In such an example, a particular functionality of the first component may be dependent of a second component. The functionality status of the first component can be based at least in part on the determination of the availability of the functionality of the first component that relies on the second component of the PKI system. In an example, if the second component is non-functional or otherwise cannot provide the functionality that is required for the availability of a functionality of the first component, then the first component may not be able to perform the functionality of the first component, or such functionality may be unavailable through/by the first component.

In a further embodiment, a third check of the first component can also be performed. The third check can determine a third availability of a third functionality of the first component, such as the availability of the third functionality of the first component. The functionality status of the first component can be further based at least in part on the determination of the third availability status.

### BRIEF DESCRIPTION OF THE DRAWINGS

FIG. 1 illustrates an example system for monitoring a PKI system.

FIGS. 2A-2B illustrates an example PKI system monitoring method.

FIG. 3 illustrates an example method of configuring an alert in a PKI monitoring system.

FIG. 4 illustrates an example functionality monitoring feature method.

FIG. 5 illustrates an example PKI system auditing method.

### DETAILED DESCRIPTION

Public Key infrastructure (PKI) are systems of roles, policies, hardware, software, and processes that manage public key encryption and generate, store, manage and revoke digital certificates. PKI systems allow for the secure transfer of information by allowing the information exchanged to be validated and communicating parties to be properly identified. As such, PKI systems are commonplace in many of today's electronic communications networks, such as the Internet.

There are many application of PKI systems. These applications can be accessible to the public at larger or can be restricted to select entities and/or users. That is, PKI systems can be private, such as for use by a company and its employees. These private PKI systems can be entirely private or may be partially private or privately administered for the purposes of a specific entity.

Many entities employ PKI systems as part of their network security, particularly for authentication of users. Companies may have various data and/or applications that are restricted to as to prevent the misuse or theft of information. Since employees need access to the data and/or applications, the Company needs a method for securely managing such access. PKI systems fill this role by issuing, managing and revoking digital certificates that can be associated with individual employees and their roles. Since PKI systems are one of the important points of network security for an entity, it is important that such systems are secured and monitored for potential security issues.

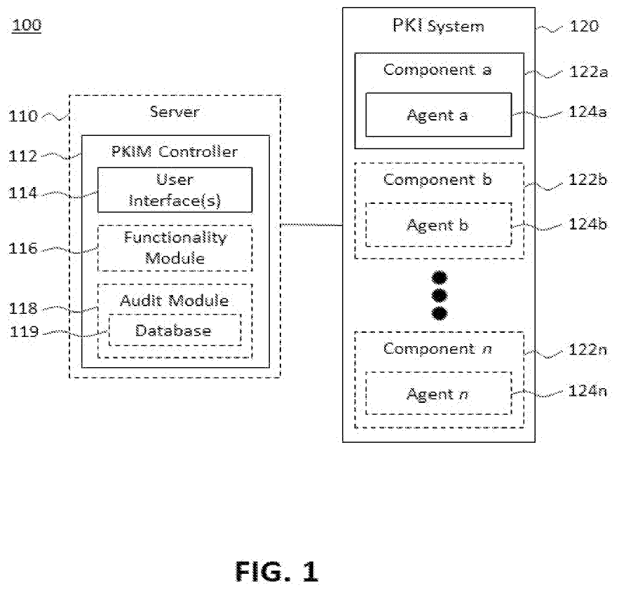

FIG. 1 illustrates an example PKI monitoring (PKIM) system 100. The system 100 includes a server 110, on which a PKIM controller 112 is installed, and a PKI system 120 that is communicatively coupled to the server 110. The communicative coupling between the server 110 and the PKI system 120 allows the PKIM controller 112 to interact with the PKI system 120 and/or portions thereof. In an example embodiment, the server 110 can be included within the PKI system 120 or can be separate from the PKI system 120 and communicatively coupled thereto, such as shown in FIG. 1.

The PKIM controller 112 can be software installed on a device, such as the server 110, or can be a hardware component that includes programming thereon. As a hardware device, the PKIM controller 112 can communicatively couple to the PKI system 120, or be included therein, without being installed on the server 110. In a further example embodiment, the PKIM controller 112 can be a combination of hardware and software. As a combination of hardware and software, the PKIM controller 112 can be wholly or partially included in or installed on a device, such as the server 110. Alternatively, the PKIM controller 112 can be distributed across multiple devices and/or systems. In a further alternative, the combination software and hardware PKIM controller 112 can be wholly or partially included in the PKI system 120.

The PKI system 120 includes various components 122a-122n that provide and/or support the functionality of a public key infrastructure system, such as 120. The components 122a-122n can include a various servers, modules and/or other components. In an example embodiment, the components 122a-122n can include an Active Directory Certificate Services (ADCS) servers, Hardware Security Modules (HSM), certification authority related components, registration authority related components, verification authority related components and/other components.

The various components 122a-122n of the PKI system 120 can be co-located or can be distributed. In an example, a portion of the components 122a-122n of the PKI system 120 can be located at premise of the PKI system 120 user and another portion of the components 122a-122n can be at a remote location, such as in a distributed computing environment, cloud computing environment, server farm, and/or other location(s). In this example, the off-premise portion of the components 122a-122n can be controlled or administered by the user/operator of the PKI system 120 or can be administered by another party for use by the user/operator of the PKI system 120, such as administered by a service provider. In another embodiment, the PKIM system 100 can be deployed in a user's cloud environment, with the PKIM controller 112 residing in the cloud to monitor the various PKI components 122a-122n within and/or coupled thereto.

As part of the PKIM system 100, agents 124a-124n are installed on the components 122a-122n of the PKI system 120. The agents 124a-124n collect data regarding the operation of the components 122a-122n the agents 124a-124n are installed thereon. Each of the agents 124a-124n transmits the collected data back to the PKIM controller 112.

Additionally, the agents 124a-124n, or portion(s) thereof, can receive communications from the PKIM controller 112. In this manner, one or more of the agents 124a-124n can communicate with the PKIM controller 112, to both send information to the PKIM controller 112 and receive information therefrom. This allows the PKIM controller 112 to send instructions to the agents 124a-124n, or portion(s) thereof, such as to cause the agents 124a-124n to take one or more actions. For example, the PKIM controller 112 can send an instruction to an agent 124a-124n requesting the status of the corresponding component 122a-122n on which the agent 124a-124n resided. The agent 124a-124n that receives such instruction from the PKIM controller 112 can initiate a functionality or other test of the corresponding component 122a-122n and communicate the results of the test back to the PKIM controller 112.

In an embodiment, the PKIM controller 112 can cause or perform the installation of one or more of the agents 124a-124n onto one or more of the components 122a-122n of the PKI system 120. The installation of an agent 124a-124n on a component 122a-122n of the PKI system 120 can be manually instructed, such as through a user interface 114 of, or associated with, the PKIM controller 112, can be automatic, or a combination thereof. In an example embodiment in which the PKIM controller 112 automatically installs agents 124a-124n on the components 122a-122n, the PKIM controller 112 can detect a component 122a-122n of the PKI system 120 that does not have an agent 124a-124n installed thereon and automatically instruct or cause the installation of an agent 124a-124n onto the detected component 122a-122n. In an example, such functionality allows the PKIM controller 122 to automatically detect and identify components 122a-122n of the PKI system 120 and install agents 124a-124n thereon, without the need for a user to instruct such installation. This can provide a benefit if new components are added to or components are replaced within the PKI system 120.

As previously discussed, the PKIM controller 112 receives and processes data from agents 124a-124n that are installed on various components 122a-122n of a PKI system 120. To interact with the PKIM controller 112, the user interface 114 can be used. The user interface 114 can communicate information to a user regarding the status of the PKIM system 100, such as an operation status of the PKI system 120 and/or components 122a-122n thereof. Additionally, the user interface 114 can be used to issue commands to the PKIM system 100, such as to test or acquire a status of one or more components 122a-122n of the PKI system 120.

Further, the user interface 114 can allow or facilitate remote interaction with the PKIM system 100. For example, a user can connect remotely to the user interface 114 to interact with the PKIM system 100, such as to issue instructions, receive information regarding the operation of the PKIM system 100, and/or other interactions.

The user interface 114 can be a single user interface that a user navigates through to access various functions, features and/or capabilities of the PKIM system 100. In an alternative, the user interface 114 can include multiple user interfaces, such as separate user interfaces 114, each of which is associated with one or more functions, features and/or capabilities of the PKIM system 100. Additionally, the user interface(s) 114 can be user-customizable, allowing the user to configure one or more setting or parameters of a user interface(s) 114. In this manner, the information displayed and/or accessible functions, features and/or capabilities displayed to the user can be customized by the user. This can allow a user to customize the user interface(s) 114 to their particular needs or purposes, such as based on the role of the user.

The user interface 114 can be accessed through various means, such as a dedicated application, a web page/website, and/or other accessibility option. In an example, the user interface 114 can be an applications, such as a web portal application. The web portal application can include the one or more user interfaces 114 that are accessible to the user and these interfaces 114 can relay information regarding the PKI system 120 and/or allow the user to configure one or more of the PKIM controller 112 or agents 124a-124n. Further, the interfaces 114 may be configurable by the user based on their preferences, such as selected information to be displayed and/or the manner in which information is displayed.

The user interface(s) 114 accessible to a user can be based on an assigned role and/or permissions level. For example, an administrator may have access to a user interface 1114 having more functionality, capabilities, and/or access to additional features than another user. The roles and/or permission levels can be access and interacted with through one or more of the user interfaces 114, such as a control or management user interface.

The PKIM controller 112 and/or the agents 124a-124n, as mentioned previously, are configurable through user interaction the user interfaces 114. The user can configure various operations PKIM controller, such as alerts or notifications regarding various aspects of the PKIM controller 112. Similarly, the user can configure various operations of one or more of the agents 124a-124n, such as alerts or notifications regarding various aspects of the agents 124a-124n. In an example embodiment, the PKIM controller 112 can include predefined alerts that can be selected by the user to configure alerts for various operations or aspects of the PKIM controller 112 and/or the agents 124a-124n. In another example, the predefined alerts can be in the form of a template that allows the user to configure one or more aspects of the predefined alert, such as a variable threshold level and/or dependency on an operational aspect of the PKIM system 100.

One of the example configurable aspects of the PKIM controller 112 can include configuring the controller 112 for access by other users. In many cases, a user may have an outside party manage or assist with various aspects of their IT infrastructure, including monitoring and maintaining the PKI system. The user can configure the PKIM controller 112 so that a third-party may access the controller 112 to view data and/or receive alerts regarding the PKI system 120. In an example, the third-party access can include transmission and storage of the collected monitoring system gathered by the PKIM controller 112, such as storage in a cloud storage or other third-party managed data storage environment.

As previously mentioned, the agents 124a-124n communicate back to the PKIM controller 112 to provide data regarding the components 122a-122n of the PKI system 120 that the agents 124a-124n are associated with. The PKIM controller 112 processes and analyses the data to provide a user with insight into the PKI system 120, such as its functionality, security and more.

The PKI system 120 of FIG. 1 can be an internal PKI system. That is, the PKI system 120 can be controlled and administered by a single entity, such as a company or other entity. Alternatively, the PKI system 120 can be an external of public PKI system that an entity contracts with and/or otherwise utilizes, such as a cloud-based PKI service. In a further alternative, a portion(s) of the PKI system 120 can be internal and the other portion(s) can be external/public. For example, an entity may choose to use a public certificate authority (CA) as part of their PKI system 120. Regardless of the distribution and/or location of the PKI system 120, the PKIM system 100 can interface with, monitor, administer and/or otherwise interact with such PKI system(s) 120. This will allow users to expand the monitoring of their PKI resources and gain additional insight into them.

To assist with monitoring the security of a PKI system 120, the PKIM controller 112 can monitor various actions that occur within the PKI system 120. The monitored interactions can include any sort of actions taken by one or more of the components 122a-122n and/or commands or interactions therewith. The granular monitoring of the PKI system 120 allows actions within the PKI system 120 to be correlated and tracked. Since many actions in and of themselves may not be suspicious, this level of monitoring can be important, since it is the combination and/or order of actions within the PKI system 120 that can be indicative of potential security threats and/or vulnerabilities. The PKIM controller 112 tracks and monitors the actions within the PKI system 120 using data collected from and/or provided by the agents 124a-124 and/or other elements/components of the PKI system 120 to determine or detect security and/or functionality issues related to the PKI system 120. As such, the PKIM system 100 is able to monitor and correlate actions within the PKI system 120 and provide alerts for suspicious activity. Further, the PKIM controller 112 can also be programmed or instructed to initiate one or more actions in response to the suspicious activity detected or determined.

In an example, the PKIM system 100 may detect that there was a pattern of accessing various component 122a-122n of the PKI system 100 that resulted in a certificate with unusually broad or high-level permissions being generated within the PKI system 120. The PKIM system 100 may know that certificates such as these are rarely issued and may provide an alert. Additionally, the PKIM system 100 can trace the pattern of access that was used to generate this certificate and provide insight into that process so that the user may determine if the certificate was properly or fraudulently generated. This ability to trace the path of actions within a PKI system 100 is beneficial in providing the user insight into where vulnerabilities lie within the PKI system and/or if there were breaches of a particular user's PKI information, such as credentials.

Additionally, with the granular level of monitoring, the PKIM controller 112 can learn and adapt to a monitored PKI system 120. In this manner, the PKIM controller 112 can not only be instructed or programmed to recognize potential security issues, the PKIM controller 112 can “learn” the normal operations of the PKI system 120 and provide alerts when operations deviate therefrom, such as may be indicative of a security issue. This “learning” ability can be instituted using machine learning based on the monitored PKI system 120. Additionally, this “learning” can be supplemented using data from other PKIM controllers 112 that monitor other PKI systems 120, using data provided by a manufacturer or vendor of the PKIM system 100, and/or other sources.

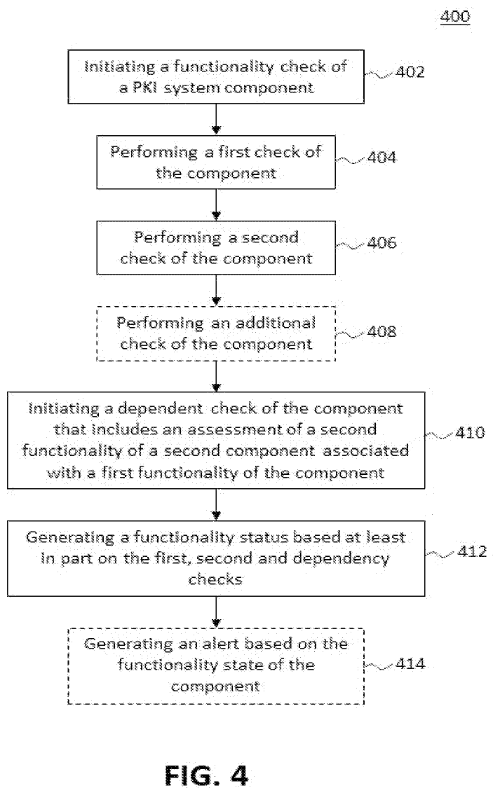

The PKIM controller 112 can also include a functionality module 116. The functionality module 116 is able to perform functionality checks of the various components 122a-122n of the PKI system 120. The functionality check is able to determine if a component is available for use in the PKI system and also determine if the component is able to perform the necessary and/or expected actions. The functionality checking process is further described in FIG. 4, discussed below.

One or more of the components 122a-122n of the PKI system 120 can have a proper or desired configuration and/or operation. The proper or desired configuration and/or operation of a component of the PKI system 120 can assist in ensuring that the component is operating as needed within the PKI system 120, assist in securing the PKI system 120 and/or other benefits. The proper or desired configuration and/or operation of a component of the PKI system 120 can be defined by a policy that can be stored and referenced. In an example, the policy can be a best practice that has been codified into a policy that outlines the proper or desired configuration and/or operation of a component of the PKI system 120. A component of the PKI system 120 can have one or more associated policies or best practices. These policies or best practices can be stored in a database 119 accessible to the PKIM system 100, such as included in the PKIM system 100 or communicably coupled thereto. The stored policies or best practices can be modified, such as revised, added or deleted. The modification of the stored policies or best practices can be automatic, such as through an update to the PKIM system 100 by a service provider or other. Additionally, the user of the PKIM system 100 can optionally modify the stored policies or best practices, such as to conform the policies or best practices to the company or user's needs. In some examples, the user may be prevented from editing portions of a policy or best practice, or may require additional permissions to be able to do so, so as to prevent modifications to a policy or best practice that could compromise or impact the operation and/or security of the PKIM system 100.

The PKIM controller 112 can also include an audit module 118. The audit module can assist with implementing and enforcing policies within the PKI system 120, such as best practices and/or other policies, as discussed above. The audit module 118 can receive information regarding the operation and/or configuration of the various components 122a-122n of the PKI system 120 and compare that to stored information, such as policies, that outline the desired/expected operation and/or configuration of the various components 122a-122n of the PKI system 120. The policies and/or best practices associated with a PKI system 120 and its components 122a-122n can be stored in a database that is accessible to the audit module 118. If there are mismatched between the actual and stored information regarding the operation and/or configuration of the various components 122a-122n, the audit module 118 can generate and alert to a user and/or can automatically adjust the operation and/or configuration of the various components 122a-122n to correct the mismatch. In this manner, the audit module 118 can audit the operation and/or configuration of the components 122a-122n of the PKI system 120 to assist with maintaining their operation/configuration in-line with predetermined policies, such as best practice policies.

As previously discussed, the PKIM system 100 can have one or plurality of user interfaces 114 through which information can be conveyed to a user and through which a user can interact with the PKIM system 100 and/or the PKI system 120. Aspects of one or more of the interfaces may be configurable by the user, such as how the user interface is displayed and/or information contained therein. A sidebar or other navigational tools may be provided to allow the user to navigate through various user interfaces 114, such as by the type of action or monitoring that is to be interacted with and/or by type of components 122a-122n of the PKI system 120.

In a landing or main screen of one of the user interfaces 114, the user may be provided an overview of their PKI system 120 monitoring by the PKIM system 100, and the controller 112 thereof. In this view, the user can be provided visual indications regarding the status of the PKI system 120, such as the active and inactive agents 124a-124n, and/or any alerts or warnings generated by the PKIM system 100, or controller 112 thereof. Additionally, the user may be provided various filters to allow them to narrow or refine their viewing of the displayed information, allowing the user to quickly receive and view relevant information.

One or more of the components 122a-122n of the PKI system 120 can have a policy configuration associated therewith. The policy configuration can provide guidance and/or instructions regarding how the component 122a-122n is to act or function within the PKU system 100. This can include various configuration settings, operating parameters, security settings, etc. Through one or more of the user interfaces 114, a user can be able to view the current policy configurations of one or more of the various components 122a-122n of the PKI system 120, such as certificate authority (CA) components. Each component 122a-122n can be displayed as a tile in which its policy configuration is displayed. This provides the user an easily understandable and viewable means of reviewing the policy configurations of one or more particular components 122a-122n. In this manner, the user can review the policy configuration of a component 122a-122n to verify that it is properly configured and can compare the policy configurations between components 122a-122n. Viewing the policy configuration similarities between components 122a-122n will allow the user to view if similar components 122a-122n are similarly configured, as would be expected. Alternative views and interactions with the policy configuration(s) of the components 122a-122n are also an option. For example, the policy configuration can be a textual table or other format, such as a predefined format. Further the policy configuration of a single component 122a-122n or the policy configuration of each of a plurality of components 122a-122n can be displayed in one or more of the user interfaces 114.

In another of the user interfaces 114, the user can review info regarding other components 122a-122n, such as hardware security modules (HSMs). The user can be presented information regarding the status and/or use of each of the HSMs, where they can determine if the HSMs are functioning as expected or needed within the PKI system 120. Additionally, configuration information for each of the HSMs can be viewed to determine if they are properly configured or are configured as expected. If there is a conflict between the current configuration of a component and the expected configuration, such as may be outlined or provided in a policy configuration associated with the component, the conflicting configuration can be flagged or alerted to in the user interface 114. Further, an alert indicating a firmware update may be provided to the user to notify them that one or more of the monitored HSMs needs updating to minimize potential security risks.

In another of the user interfaces 114, the user can review information regarding the various online certificate status protocol (OCSP) services that are used by the PKI system 120. Here the user can see the various OCSP services that are being used and the permissions associated with each. The permissions for each service can be displayed in a corresponding tile or other delineation to allow the user to review if permissions for an OCSP service has changed. This provides additional security monitoring, as the changing of these permissions may present a potential vulnerability in the PKI system 100. Additionally, alerts can be configured to notify a user or other when such permission changes occur, so that they may be reviewed for potential security implications.

In a further one of the user interfaces 114, the user can review the various CAs from which issued certificates are authorized for use within the PKI system 120. The authorized CAs can include both internal and external CAs. Through this one of the user interfaces 114, the user can review the listed CAs and determine if one has been maliciously added or altered. Additionally, functionality may be provided through this or another of the user interfaces 114 to allow the user to revoke or edit the status or authorization of one of the listed CAs. Further, alerts may be configured to notify the user regarding changes to the listed CAs, such as changes in status, configuration, authorization or other aspects regarding one of the listed CAs.

Another one of the user interfaces 114 may provide an event viewer. Here the user can view various events within the PKI system 120 and/or components 122a-122n thereof. The events may be automatically assigned a classification and/or importance level by the PKIM system 100, such as to indicate a type of an event and/or the security risk associated with the event. Additionally, the events may also be categorized as being related to the agents 124a-124n or the controller 112, such as events of a component 122a-122n or system events, respectively. Various filters can be provided to allow the user to filter the events to a subset. Further, reporting tools may be included to allow the user to generate a report that includes one or more of the events and, optionally, information associated therewith. In an example, the reporting functionality can be user-configurable to callow the user to define a report and a schedule for which the report should be generated. This can automate the reporting and/or recording of the event history.

In an additional one of the user interfaces 114, a user can be provided tools or options to configure alerts and/or notifications. The user can select various parameters and/or define values thereof that will trigger an alert. Further, the user can define the delivery of the alert, such as the recipients and means of communicating the alert. The PKIM system 100 can include functionality to assist the user with configuring alerts and also include functionality that adapts to a user. The adaptive functionality can provide tools and/or actions that assist the user with configuring alerts based on their previous configuration of alerts, such as classifying a level of an alert, automatically completing recipients for an alert and other assistance to increase the efficiency of configuring the alerts by a user.

Additionally, or alternatively, the alerts/notifications can include predefined alerts/notifications. These predefined alerts can include triggering parameters that are based on industry best practices, recommended settings, and/or other criteria. In this manner, the burden of configuring an alert can be shifted off of the user or administrator of the PKIM system 100. Additionally, the predefined alerts can also assist in preventing the user or administrator from inadvertently overlooking configuring of an alert. This can help to ensure that the PKIM monitoring system 100 maintains a certain level of monitoring awareness, such as for security issues.

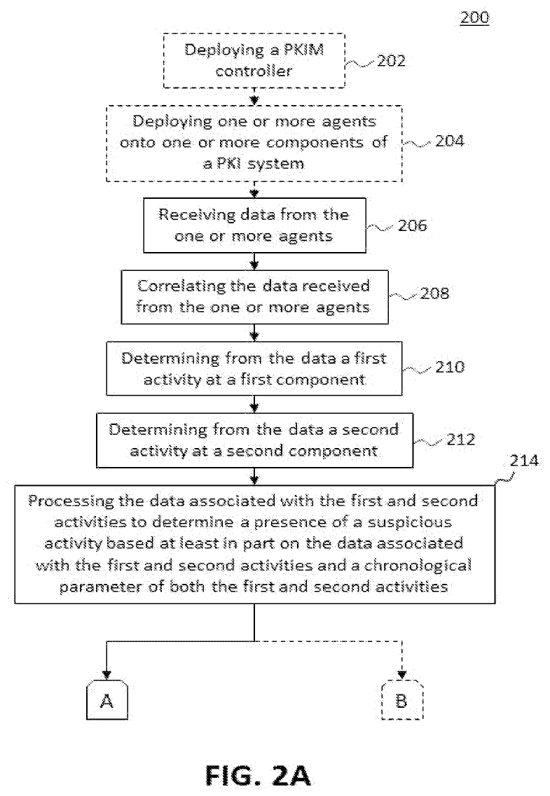

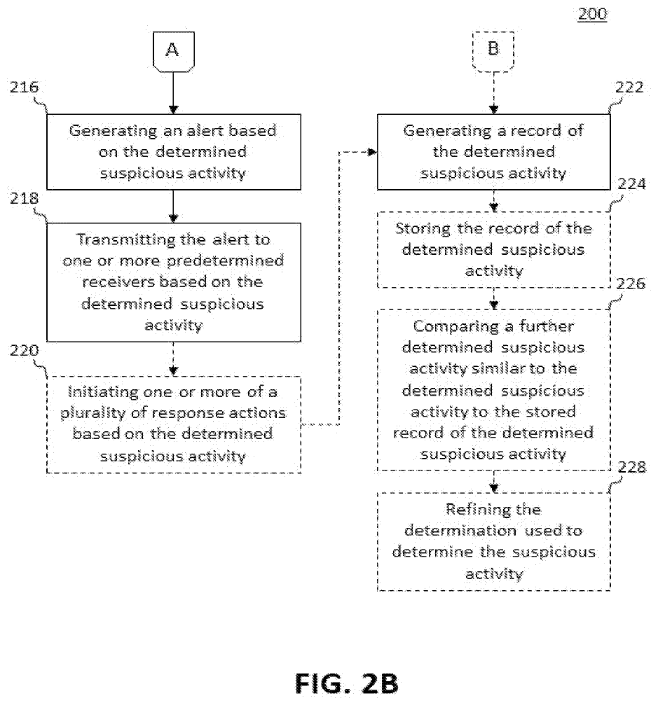

FIGS. 2A-2B illustrates an example PKI monitoring method 200, such as might be performed by/using the PKIM monitoring system 100 of FIG. 1. The PKI monitoring method 200 monitors a PKI system, such as 120 of FIG. 1, for suspicious activity that may be indicative of a security threat or issue.

At 202, optionally, a PKI monitoring (PKIM) controller, such as 112 of FIG. 1, is deployed. The PKIM controller can be deployed to a server or other location, such as depending on the nature of the PKI system to be monitored. For example, in an internal or private PKI system, the PKIM controller can be deployed or installed on a server. In another example, in a public, managed or cloud-based PKI system, the PKIM controller can be deployed or installed therein, such as on a virtual machine, physical server and/or other within the environment.

At 204, optionally, one or more agents are deployed onto one or more components of the PKI system to be monitored. The agents are deployed or installed onto the one or more components of the PKI system, such as 124a-124n and 122a-122n of FIG. 1. That is one or more components of the PKI system can have one or more agents installed or deployed thereon. The agents may be specific or configured dependent on the component to which they are deployed, such as a hardware security module (HSM), or other PKI system component.

At 206, data from the one or more agents is received. The agents collect and send data to the PKIM controller from the various PKI system components which they are deployed on. The data collected is indicative of one or more aspects of the component, such as functionality data, operating data, access data, etc. The data collected by the agent can be specified when configuring the agent and/or instructed by or through the PKIM controller.

At 208, the received data is optionally correlated. The correlation of data establishes, identifies or determines connections between the received data. For example, an action at a first component of the PKI system can trigger a second action at a second component of the PKI system. Both the first and second actions would be reported by respective agents to the PKIM controller. The PKIM controller can include logic, programming, and/or other instruction, that allows the first and second actions to be correlated to each other and the PKIM controller can then process the first and second actions individually and as part of a larger overall action. This can assist in preventing false notifications of security issues, assist in verifying functionality of the PKI system and components thereof, and/or other monitoring actions.

At 210, a first activity at a first component of the PKI system is determined from the received data. The first activity can be an action performed by the component, an instruction to the component, an access to the component, an interaction with the component, and/or other parameter/characteristic of the component. Similarly, at 212, a second activity at a second component of the PKI system is determined from the received data. Like the first activity, the second activity can be an action performed by the component, an instruction to the component, an access to the component, an interaction with the component, and/or other parameter/characteristic of the component.

At 214, data associated with the first and second activities is processed to determine a presence of suspicious activity based at least in part on the data associated with the first and second activities and a chronological parameter of both the first and second activities. The chronological parameter can be a time of both the first and second activities, a time between the first and second activities and/or other chronological characteristic in regards to the first and second activities. The presence of suspicious activity is determined based on the data associated with the first and second activities and the noted chronological parameter. The data associated with each of the respective activities can be one or more data elements associated with the activity, such as an action, interaction, access and/or other related data. For example the data associated with the first activity can be a creation of a high-level digital certificate and the data associated with the second activity can be the use of the high-level digital certificate to access data. The chronological parameter can be the time between the first and second activities and can be a short duration. The combination of a high-level digital certificate being created and used within a short time duration can be indicative of potential suspicious activity. Alternatively, other data associated first and second activities and other chronological parameters are also able to be used to determine the presence of suspicious activities.

At 216, an alert is generated based on the determined suspicious activity and at 218 the alert is transmitted to one or more receivers based on the suspicion activity. The alert can be a notification and/or alarm, such as an email, text message, instant message, audible output, visual output and/or other form of notification or alarm. The receiver of the alert can be a user or multiple users associated with the PKI system and/or PKIM system. The users contacted to receive the alert can be predetermined based on the alert and/or based on a predefined list of users to be notified of alerts. For example a first subset of users can be predefined to receive alerts of a first type and a second subset of users can be predefined to receive alerts of a second type. Further, in the example, users can be included in bother the first and second subsets. Alternatively, in the example, the users can be unique to each of the first and second subsets.

At 220, optionally, one of a plurality of response actions are initiated based on the determined suspicious activity. The response action initiated is based on the suspicious activity. For example, the response action can include revoking a digital certificate, preventing access to the PKI system by a user, removing/isolating a component of the PKI system, temporarily suspending the PKI system, and/or other actions related to the operation of the PKI system and/or its components. Alternatively, the response action can include recording or documenting the activity and/or other data associated with the suspicious activity. A user of the PKIM system can define or select the response action and associate with one or more triggering parameters that are based on suspicious activity. In this manner, a suspicious activity causes one or more response actions to be initiated. In an alternate embodiment, the PKIM system can include predefined response actions associated with suspicious activities. This can reduce the burden on a user to define and configure response actions. Further, the predefined response actions can be reconfigured or modified by the user of the PKIM system, including disabling or enabling one or more of the predefined response actions.

At 222, optionally, a record of the suspicious activity is generated. The record can include data regarding the suspicious activity, such as the PKI system components involved, data from the involved PKI system components, PKI system data, timing, and/or other data. The record can have a standardized or other format. At 224, optionally, the generated record of the suspicious activity is stored. The storage of the record can be in a database and/or other storage location, system or device.

At 226, optionally, a further determined suspicious activity that is similar to the stored record of suspicious activity is compared to the stored record of suspicious activity. In this manner, it can be determined the similarities and differences between the different instances of suspicious activity. At 228, the determination used to determine the suspicious activity, such as the determination at 214, is refined. In this manner, the PKIM systems and methods can be adaptable and “learn” from the record of suspicious activities. This ability allows the PKIM to evolve as it experiences additional suspicious activity events or occurrences. Further, this learning can be shared externally to allow other PKIM systems to also be further refined. Further, the suspicious activity records can be shared communally or centrally and the learnings can be distributed to the PKIM systems that are coupled thereto.

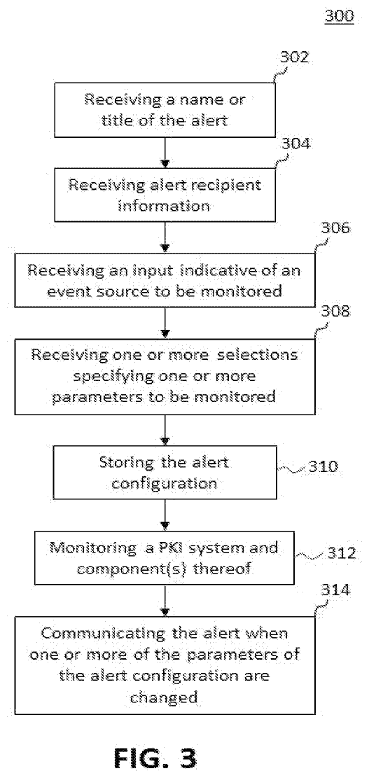

FIG. 3 illustrates an example method 300 of configuring an alert within a PKIM system, such as 100 of FIG. 1. The alert can be a custom alert that is defined by the user. Alternatively, the user can begin the configuration of an alert using a template or modification of a predefined alert. At 302, a user can provide a title for the alert. The title may be descriptive of or related to the aspect of the PKI system to which the alert relates. However, the user may customize the title as they desire and/or may be provided options or recommendations. In a further example, the title of an alert may be generated automatically based on the configuration of the alert, as provided by the user.

At 304, the user can specify or provide information regarding recipients for the alert. The recipients for the alert are individuals or user to which the alert will be communicated. The recipients may be selected from a list of users of the PKIM system and/or can be manually entered. Multiple means of communication can be supported for communicating the alert, such as email, text message and/or other notification means. Alternatively, or additionally, the recipient of the alert can be another system, such as a network security system and/or other system. This other system can, in-turn, alert particular user(s) and/or take an action in response to the received alert.

At 306, the user may select the source of an event for which the alert is to be generated. That is, the user can define or select an element(s) of the PKIM system the alert pertains to, such as an agent or a controller of the PKIM system and/or a component of the PKI system. The source for the event is the entity(s) of the PKIM/PKI system for which the alert in regards to.

At 308, the user can select or input various parameters of the alert. The parameters can include a specific source that should be monitored, such as a specific agent, component and/or an aspect of the PKI system for which the alert is associated with. When one of the selected aspects of the PKI system changes, the alert will be triggered. For example, the user can configure the alert to be notified when there is a change to one of the CA services that the PKIM system is monitoring. When a change in such an aspect of the PKI system is detected the PKIM system generates and communicates the alert to various recipients, such as those defined at 304. Alternatively, or additionally, the alert can be based on the magnitude of a change associated with the specific source being monitored. For example, a threshold number of failed logins can be a trigger, a threshold amount of login attempts over a period of time, and/or other individual and/or time-based parameter(s).

Once the alert has been configured, the user confirms and saves the alert at 310. With the alert now active, when changes in the selected aspects of the PKI system are detected, the alert will be communicated. Once configured, the user can review and edit the alert configuration and can selectively activate or deactivate the alert.

At 312, the PKIM system monitors the various PKI system(s) and components thereof. The monitoring at 212 can include monitoring in regards to the alert. When a parameter of the PKI system(s) and/or components thereof is outside that defined in the alert, the alert can be communicated at 314.

In an example embodiment, the PKIM system can include preconfigured alerts that the user can activate and provide recipient information for. The preconfigured alerts can be based on common or critically important aspects of the PKI system for which a user should be notified when changes occur.

The PKIM system, such as 100 of FIG. 1, can also include a functionality monitoring functionality that checks the functionality of the various PKI components, such as 122a-122n, to determine if the components are able to perform their duties or expected actions. The functionality monitoring can include that the component 122a-122n is connected and accessible to the PKI network, along with additional checks to determine that the component 122a-122n is prepared for and capable of performing requested tasks and/or operations.

In PKI systems, some components may be used or accessed infrequently. Because of this lack of regular use, a user may not know that the component is non-functional or not functioning as expected until that component is needed. However, when that component is needed and it is not functioning, disruptions are likely to occur that will adversely impact the user or their organization. The functionality monitoring is able to check the functionality and return results that indicate whether the component is ready for use or not. This helps to ensure that the components of the PKI system are fully functional and ready when called upon.

The functionality monitoring utilizes a series of checks to determine if one or more components of a PKI system, such as components 122a-122n of PKI system 100 of FIG. 1, are functioning properly. Some of the checks include determining whether the component has the necessary read/write functionality available to it; whether new requests can be properly processed by the component; whether the trust chain for a component is valid; whether a necessary HSM or other cryptographic key is available to the component; and/or other checks. In this manner, not only is the functionality of the service of the component checked, but so are the necessary up and/or downstream interactions. This allows the PKIM system to report that a component is properly functioning or if there is an issue that would otherwise prevent the component from being able to successfully perform its service or functionality.

FIG. 4 is an example method 400 as may be utilized by the functionality monitoring feature. The various processes or steps of the method 400 can be initiated by a controller of a PKIM system, with the PKIM controller communicating to the component and/or agent thereon. In other embodiments, the agent may initiate and/or perform the various processes and/or steps of the method 400. In yet another embodiment, the controller and agent may both assist in performing and/or instructing the various processes and/or steps of the method 400.

At 402, a functionality check of a component can be initiated. The functionality monitoring feature and accompanying check can be implemented for all or some of the components of a PKI system. Additionally, the schedule for running the functionality monitoring feature can be optionally specified by the user or utilize a default schedule as provided in the PKIM system. Alternatively, the functionality check can be conditionally triggered, such as based on detected or reported events by a controller and/or agent of the PKIM system, such as controller 112 and/or agents 124a-124n of FIG. 1.

At 404, a first check of the component is performed to determine if a first functionality of the component is available. In an example embodiment, the first check can include determining that the component is reachable or that the component is online and communicating with the PKI system.

At 406, a second check of the component is performed to determine if a second functionality of the component is available. In an example, the second check can include determining if the component can read/write to a database associated with the component, validating a trust chain associated with the component and/or validating that a request can be processed by the component.

At 408, optional further checks of the component can be performed to determine if additional functionality of the component is available or functional.

At 410, a dependency check is performed to determine if a functionality of the component that relies on another component is available. In many PKI systems, a component may rely on another of the components for being able to fulfill requests. In an example, a CA may rely on a HSM to sign data on behalf of the CA. The dependency check is able to determine if these dependencies are functional. The dependency(s) to be checked may vary based on the component. The functionality monitoring feature can include these dependencies and perform these checks and/or a user can specify dependencies for the feature to check when determining the functionality status of a component of the PKI system, such as 122a-122n of FIG. 1.

At 412, a functionality status is generated. The functionality status of a component may be communicated or displayed, such as in or through a user interface of the PKIM system. Here, a user can view the functionality status of one or more components of the PKI system. At 414, an optional alert can be generated based on the functionality status of a component of the PKI system. If the component is determined to not be alive or functional, an alert can be communicated to a user or others to inform them of the non-functional status of the component. In an example embodiment, the PKIM system can provide recommendations for remedying the non-functional status of a component and/or can provide diagnostic tools to assist in determining a cause and/or remedying the non-functional status of the component.

The audit module 118 of the PKIM system 100 can receive and/or request data regarding the operation and/or configuration of one or more components 122a-122n of the PKI system 120. The audit module 118 compares the operation and/or configuration data to stored policy data, such as best practice data, to determine if the one or more components 122a-122n of the PKI system 120 is operating and/or configured as expected. If the operation and/or configuration of a component of the PKI system 120 conflicts with that outlined in the stored policy, the audit module 118 can record the occurrence of such an instance and details related thereto and/or issue an alert to a user of the PKIM system 100 to inform them of the conflict. In an example embodiment, the audit module 118 can modify the operation and/or configuration of the component of the PKI system 120 so that the operation and/or configuration is more aligned with that of the policy. In some examples, the audit module 118 can be capable of fully modifying the operation and/or configuration of the component of the PKI system 120. In another example, the audit module may by capable of modifying at least a portion of the operation and/or configuration of the component of the PKI system 120. In an example embodiment, the ability of the audit module 118 to modify the operation and/or configuration of the component of the PKI system 120 may be due to the permissions granted to the audit module 118, the type of component, the configuration of the component and/or other factors.

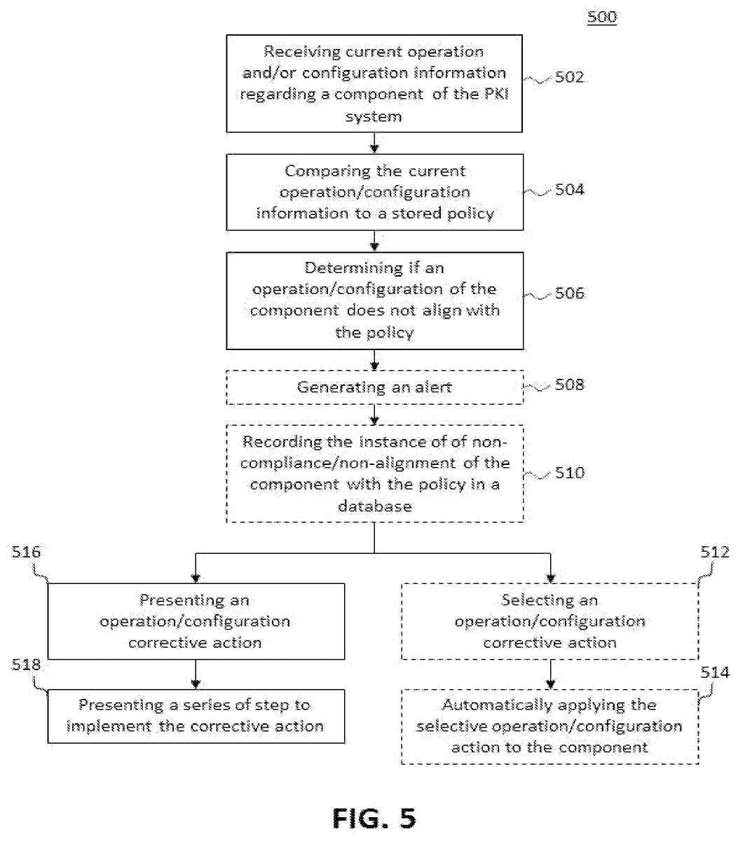

FIG. 5 illustrates an example method 500 of auditing a PKI system, such as 120 of FIG. 1, for compliance with one or more policies and/or best practices. The auditing process can be performed by a PKIM system, such as 100 of FIG. 1, and/or an audit module thereof, such as 118 of FIG. 1. The auditing of the PKI system can assist in maintaining the operational and/or secure status of the PKI system. Components of the PKI system may be operating incorrectly and/or misconfigured, causing the operation of the PKI system to be downgraded and/or the security of the PKI system to be compromised. The auditing of the PKI system can occur at regular intervals, such as on a schedule, on demand, or continuously (or substantially continuously). In this manner, the operation and/or configuration of the components of the PKI system can be monitored and corrected, as necessary.

At 502, current operational and/or configuration information regarding a component of a PKI system is received. In an example, an agent 124a-124n of the PKIM system 100 can collect and send such information to the audit module 118 of the PKIM system 100, from the various PKI system components 122a-122n. The agents 124a-124n can be scheduled to regularly transmit such information to the PKIM system 100 and/or audit module 118 thereof. This operation/configuration information of the components 122a-122n can be included in the normal communications between the agents 124a-124n and the PKIM controller 112. Alternatively, the communication of such information can be separate from the normal communications between the agents 124a-124n and the PKIM controller 112. In another example, various trigger(s) can be configured for one or more of the agents 124a-124n, to cause them to transmit operation/configuration information to the PKIM system 100 and/or audit module 118 thereof. Alternatively, the operation and/or configuration information can be requested or retrieved, such as by a PKIM system 100 and/or audit module 118 thereof.

At 504, the received current operational and/or configuration information of the component of the PKI system is compared to one or more stored policies. A database 119 can be included in the audit module 118 and can store policy information related to one or more components of the PKI system 120. In alternative embodiments, the database 119 can be separate from the audit module 118 and communicatively coupled thereto. The policy information related to a component of the PKI system 120 can include various desired and/or required operational and/or configuration parameters related to the component. That is, the policy can outline how a component 122a-122n of the PKI system 120 should be operating and/or configured. This stored policy is compared with the current operational and/or configuration information of the PKI system component 122a-122n to determine if the component 122a-122n is in compliance with the stored policy.

As discussed, the policy information related to the components 122a-122n of the PKI system 120 can reside in a database 119 that is accessible by the audit module 118. The policy information stored in the database can be provided by a supplier of the PKI system 120, by the user of the PKI system 120, by a third-party, or combination thereof. Additionally, the policy information can be updated or modified, such as to comply with regulations, user needs and/or other considerations. Further, the policy can include an indication of importance or criticality, in this manner, the user can ascertain whether aspects of a policy can or should be changed from the existing. The importance or criticality indication associated with a policy can indicate the potential security risk posed due to deviation from the policy, potential impact to the operation of the PKI system 120 in response to a change in the policy, and/or other consideration(s). In an example, a portion of the stored policies can be secured so as to prevent modification and/or the securement of the policies can be tiered so that only certain users are allowed to change policies of more importance or criticality. A user can also add policies to the database, these could be policies that are specific to the user's PKI system, such as company policies or procedures.

At 506, a determination is made if an operation and/or configuration of the component of the PKI system does not align with the policy. At 504, the current operation and/or configuration of the PKI system component 122a-122n is compared to the policy and at 506 it is determined whether the policy and the current operation and/or configuration of the component 122a-122n align. The policy can include one or more checks or comparisons that are performed between the current operation and/or configuration of the component 122a-122n and the policy. If the policy and the current operation and/or configuration of the component 122a-122n are aligned, then it is determined that the PKI system component 122a-122n is currently aligned and/or in compliance with the policy. However, if the current operation and/or configuration of the component 122a-122n is not aligned with the policy, then it is determined that the PKI system component 122a-122n is not currently aligned or is not in compliance with the policy. This determination can include details regarding the non-compliance/non-alignment of the operation and/or configuration of the component 122a-122n, such as the policy, or portion(s) thereof, that the component 122a-122n does not comply/align with.

When it is determined that the component 122a-122n is not in compliance with the policy, a further determination can be made that indicates the severity or degree of non-compliance and/or misalignment with the policy. In an example, a policy may include more than one operation and/or configuration characteristic of the component 122a-122n. During the comparison between the policy and current operation and/or configuration of the component 122a-122n it can be determined that the current operation and/or configuration of the component 122a-122n of the component is aligned with a portion of the policy. The severity or degree of non-compliance of the policy can be indicated based on the portion of the policy that the component 122a-122n does not currently comply with. For example, a policy can outline three operation and/or configuration characteristics, and the component 122a-122n may comply with just two of the three characteristics. An indication of the compliance of the component 122a-122n with the policy can indicate that the component complies with a majority of the policy. In further examples, the operation and/or configuration characteristics of the policy can be weighted and this weighting can be further included in the indication of compliance between the component 122a-122n and the policy. In yet further examples, the indication of compliance can also include a consideration of the importance or criticality of the policy, and this consideration can be included in the ultimate indication of the compliance between the component 122a-122n and the policy. For example, non-compliance with a critical policy can create a strong indication of non-compliance than non-compliance with a less critical policy. In this manner, the user can be informed of a severity or importance of a determination of non-compliance between the current operation and/or configuration of a component 122a-122n and a policy, such as stored in the database 119.

At 508, an optional alert can be generated and/or output to indicate that the determination at 506 was a determination of non-compliance and/or non-alignment between the current operation and/or configuration of the component 122a-122n and the stored policy. The alert can be an audible and/or visual alert to the user to indicate that a component 122a-122n of the PKI system 120 is not in compliance and/or not aligned with the stored policy that outlines the operation and/or configuration of the component 122a-122n. In an example, the alert can be displayed to the user on a screen, included in a communication to the user and/or other forms. The alert can also include details regarding the non-compliance/non-alignment, and optionally include a severity or criticality related to such.

At 510, optionally, a record of the determination of non-compliance/non-alignment between a component 122a-122n of the PKI system 120 and a policy can be made. The record can be generated by the audit module 118 and stored in the database 119. In this manner, an auditable trail of the policy non-compliance/non-alignment can be recorded, such as for future reference and/or to check that such issue has been remediated. The record can include details of the non-compliance/non-alignment, including a time when such was determined, the component 122a-122n involved and/or other details.

At 512, optionally, an operation and/or configuration corrective action is selected. The operation or configuration corrective action is selected based at least in part on the determined operation and/or configuration that is not in compliance or not aligned with the policy, such as determined at 506. In an example, the policy can include one or more corrective actions that can be taken to alter the operation and/or configuration of a component 122a-122n so that the operation and/or configuration of the component 122a-122n is in compliance/aligned with the policy. In another example, a plurality of corrective actions can be stored in a repository, such as database 119, and one or more can be selected therefrom. The corrective action can include altering an operation or configuration of the particular component 122a-122n, altering an operation or configuration of another component 122a-122n, altering an operation or configuration of the PKI system 120, altering an operation or configuration of the PKIM system 100, altering an operation or configuration of another component and/or system that is communicatively coupled to one or more of the PKI system and/or PKIM system, and/or a combination thereof.

At 514, optionally, the selected operation and/or configuration action is automatically applied. The corrective action selected at 512 is applied to one or more components and/or systems, such as components 122a-122n, PKI system 120, PKIM system 100 and/or other component/system. The application of the corrective action can cause a configuration and/or operational parameter/characteristic of the component 122a-122n to be altered. The alteration causes the operation and/or configuration of the component 122a-122n to align or be in compliance with the policy(s) associated with the components 122a-122n.

At 516, alternatively or in addition to 512 and 514, one or more operation and/or configuration corrective actions are presented to the user. Similar to 512, at least one corrective action that will remediate at least a portion of the non-compliance/non-alignment between the component 122a-122n and the policy is selected and presented to the user of the PKI 120 and/or PKIM system 100. The display of the one or more operation and/or configuration corrective actions can include an acceptance of a user input, such as a user-selectable icon and/or other user input. The user input can be an acknowledgement that the user is aware of the non-compliance/non-alignment issue and/or that the user is prepared to remediate the issue. In an example, the presentation of the corrective action(s) can be included in an alert, such as at 508.

At 518, a series of steps are presented to the user to guide the user in implementing the one or more corrective actions from 516. The series of steps can be presented as a checklist or other manner. Further, as the user completes a step, a user input can be accepted to acknowledge completion of a particular step. In another example, the audit module 118 can monitor the user actions in following the outlined steps and can automatically indicate when one of the steps is complete. In this manner, the user can take the necessary steps to cause the operation and/or configuration of one or more components 122a-122n of the PKI system 100 to be altered such that the components 122a-122n are in compliance with or aligned with a particular policy(s).

### Example Best Practices

### Certificate Authority Configured to Ignore Certificate Revocation Errors

Typically, on start-up of the Certificate Authority (CA), a check is performed to validate that the certificate in use by the CA is valid. This is done by checking the revocation information to ensure that the signing certificate of the CA has not been revoked. If the CA is unable to access the revocation information, the CA will not start and/or will not issue certificates.

The CA can be configured to ignore revocation checking errors. While this allows the CA to continue to operate even if it is unable to validate its signing certificate, operating in this state is a potential security issue since it will be operating in a not fully trusted state. There are a limited number of reasons why the CA should be configured in this manner, and it may be indicative of a security and/or operational issue and should be corrected.

To remediate this configuration issue, a command and/or a series of steps can be presented to enable a user to correct the configuration of the CA so that the inability to access revocation information is no longer ignored.

In response to determining a configuration error, such as the above, the audit module 118 can cause an explanation of the error to be presented to a user, along with guidance on how to remediate the error. Alternatively, the audit module 118 can initiate and perform the configuration correction on its own to resolve the configuration mismatch issue. In another example, the audit module 118 can present the user with the steps and/or commands to be used to remediate the issue, along with a selectable button that allows the user to command the audit module 118 to resolve the issue. This can serve as a means of ensuring that the user reviewed the error and took action to resolve it.

### Certificate Authority Database Disk Running Low on Memory

The Certificate Authority (CA) is configured to store its database. When the disk the database is being stored on is running low, an alert is issues. Typically, it is recommended that the disk be less than 75% full to ensure there is adequate disk space. If there is insufficient disk space, it can cause the CA to fail to issue certificates or to start up. Further, there is an increased risk that the CA database will become corrupted.

To resolve such an issue, additional disk space can be added or the CA database can be migrated to another location with more free space. The audit module 118 can present the user with the locations of the CA database folders that are required to be moved and present the user with a series of steps to successfully do so. This can include backing-up the CA database, safely stopping the CA, migrating the relevant files to the new location, updating the necessary registry keys with the new location of the CA database and restarting the CA. As noted in the previous example, the audit module 118 can be configured to perform the remediation actions on its own when such an issue is detected by the audit module 118. In another example, the audit module 118 can preset the user with a notice of the configuration issue and a button to select indicating that the user has acknowledged the notice and to cause the audit module 118 to remediate the issue.

### Certificate Authority not Configured to Enable Auditing of CA Related Activity

In some instances, the CA can be improperly configured and this can prevent auditing of the activity of the CA. There are various properties and parameters of the CA that can be configured to also provide additional visibility into the operation of the CA. Without such proper configuration, operational details of the CA may not be properly logged and this can prevent proper review of the operations of the CA when needed.

The audit module 118 can present the user with various steps to reconfigure properties and/or parameters of the CA so that proper records of the CA operations can be maintained. Additionally, the audit module 118 can provide additional advice and/or guidance regarding the operation of the CA in relation to recording the operations performed thereby, such as warning the user that certain configurations could cause performance issues with the CA, such as extending the shutdown and startup times.

Certificate Authority Missing from Cert Publishers Group in One or More Domains in the Active Directory (AD) Forest

When an Enterprise CA is installed and added to Active Directory, the computer account for the CA is automatically added to the Cert Publishers group in the domain where the CA is a member. Membership of this group enables the CA to publish certificates to user and computer objects in Active Directory, to support encryption selection operations. This is usually associated with Secure Email (S/MIME) certificates and Encrypted File System (EFS) use. If there are multiple domains in the forest, the automatic installation process does not add the CA computer object to any other domain than where the CA computer is a member. This must be done manually.

When such an issue is detected, the audit module 118 can present the user with various steps to take to remediate the issue, including adding the CA computer object to one or more members.

Certificate Authority Configured to Ignore Invalid Policy Constraints which is not Permitted in RFC 5280

Policies are used to enforce restrictions and permitted used within a PKI system by embedding policy details in extensions of issued certificates, as defined in RFC 5280. RFC 5280 states that the CA should only issue certificates that are in accordance with the policies enforced by the CA and any parent CA above it. If a certificate is requested that has a policy not in accordance with the CA, then the CA will not issue the certificate and will report an error. However, it is possible to configure the CA to allow such certificates to be issued. Such a configuration could be a security issue, since certificates could get issued that do not contain the necessary policies embedded therein.

The audit module 118 can alert the user to the existence of such an issue as this and can provide steps to allow the user to remediate the issue. The steps can include various lines of code and/or programming that can be copied and pasted as needed to reconfigure the CA so that it does not issue certificates that are not in accordance with the policies of the CA and those CA above. Alternatively, the audit module 118 can automatically correct the issue without user intervention, or can alert the user to the issue and then receive a user input that allows the audit module 118 to automatically reconfigure the CA so that is in compliance.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

1. A public key infrastructure (PKI) monitoring system, comprising:
a controller configured to communicate with one or more agents;
one or more components of a PKI system, each of the components having one or more agents installed thereon, each of the agents configured to collect data regarding the component and communicate that to the controller and receive instructions from the controller; and,
the controller including a functionality module configured to query first component of the one or more components of the PKI system and generate a functionality status of the first component based on a response to the query of the first component.

2. The PKI monitoring system of claim 1, wherein the functionality module is further configured to query a second of the one or more components of the PKI system that the first component interacts with to perform a functionality of the first component, and wherein the functionality status of the first component is further based on a response to the query of the second component.

3. The PKI monitoring system of claim 2, wherein the functionality module is further configured to output an alert indicative of one or more issues related to the first component based on the functionality status being non-functional.

4. The PKI monitoring system of claim 2, wherein the functionality module is further configured to initiate one or more diagnostic tools to diagnose an issue related to the functionality of the first component based on the functionality status being non-functional.

5. The PKI monitoring system of claim 4, wherein the functionality module is further configured to provide one or more remedies to correct the issue related to the functionality of the first component, the one or more remedies based at least in part on the diagnosis of the issue.

6. The PKI monitoring system of claim 2, wherein the functionality module is further configured to perform a third and a fourth query and determine a further functionality status of the first component.

7. The PKI monitoring system of claim 6, wherein the third query is directed to the first component and the further functionality status is based at least in part on the response to the third query by the first component.

8. The PKI monitoring system of claim 7, wherein the fourth query is directed to the second component and the further functionality status is based at least in part on the response to the fourth query by the second component.

9. The PKI monitoring system of claim 1, wherein at least a portion of the one or more components of the PKI system are within a private PKI system.

10. The PKI monitoring system of claim 1, wherein at least a portion of the one or more components of the PKI system are within a public PKI system.

11. The PKI monitoring system of claim 1, wherein the one or more components include one of a certificate authority or a hardware security module (HSM).

12. The PKI monitoring system of claim 1, wherein the controller is installed on a server that is communicatively coupled to the PKI system and the one or more components thereof.

13. The PKI monitoring system of claim 1, wherein the controller includes one or more user interfaces through which the functionality module can be interacted with to instruct the generation of the functionality status of the first component.

14. A method of monitoring a public key infrastructure (PKI) system, comprising:
initiating a functionality status check of a first component of the PKI system;
performing a first check of the first component;
performing a second check of the first component;
initiating a dependency check of the first component; and,
generating a functionality status of the first component based at least in part on the first and second checks and the dependency check of the first component.

15. The method of claim 14, wherein the first check of the first component includes determining a first availability status of a first functionality of the first component, and wherein the functionality status of the first component is based at least in part on the determination of the first availability status.

16. The method of claim 15, wherein the second check of the first component includes determining a second availability status of a second functionality of the first component, and wherein the functionality status of the first component is based at least in part on the determination of the second availability status.

17. The method of claim 14, wherein the dependency check of the first component includes determining an availability of a functionality of the first component that relies on a second component of the PKI system, and wherein the functionality status of the first component is based at least in part on the determination of the availability of the functionality of the first component that relies on the second component of the PKI system.

18. The method of claim 14, further including performing a third check of the first component, wherein the third check determines a third availability status of a third functionality of the first component, and wherein the functionality status of the first component is further based at least in part on the determination of the third availability status.

19. The method of claim 14, further including generating an alert based on the functionality status of the first component.
